(19) United States
(12) Patent Application Publication
(10) Pub. No.: US 2002/0169863 A1
(43) Pub. Date: Nov. 14, 2002

(54) Multi-client to multi-server simulation environment control system (JULEP)

(76) Inventors: Robert Beckwith, Ashland, MA (US); Robert Sanzone, Hudson, MA (US); Mary Albanese, Boston, MA (US)

Correspondence Address: LSI Logic Corporation, 1551 McCarthy Blvd., M/S: D-106 Patent Department, Milpitas, CA, 95035, US

(21) Appl. No.: 09/852,200

(22) Filed: May 8, 2001

(51) Int. Cl. G06F 15/173

(52) U.S. Cl. 709/223

(57) ABSTRACT

A software simulation system and method that improves repeatability in simulations of computer and electrical apparatuses where a messaging broker control process acts as an intermediary between one or more servers and one or more clients associated with each server. In one embodiment, the control process resides as a stand alone system from the servers and clients it regulates, and stops the servers upon each of them reaching a synchronization point. In addition, the control process orders messages received from servers to deliver to clients in a predetermined manner, using a timestamp system maintained by the control process for all user specified events.

### BACKGROUND OF THE INVENTION

1. Field of Invention The present invention relates generally to simulators of computer or electronic systems.

2. Description of Related Art

A simulation environment consists of one or more client processes and one or more server processes. For simulation to be useful, it must be repeatable, meaning each run of the simulation should produce identical results from identical input. A minimal configuration consists of a single client and a single server. In the minimal configuration, repeatability is obtained by running only one process at a time (i.e., either the client or the server). This simple approach does not work when there exist more than one client or more than one server. The present invention is concerned with creating a simulation environment which produces repeatable results in any configuration.

### SUMMARY OF THE INVENTION

An aspect of the present invention is to provide a simulation environment between one or more servers and clients that leads to repeatable outputs.

Another aspect of the present invention is to provide for a simulation environment that performs its function without the necessity for modifying a simulation kernel in any server process.

Yet another object of the invention in one preferred embodiment is to provide for a simulator that introduces another layer between server and client, a control process. All interprocess messages, such as bi-directional messages between server(s) and client(s), are mediated by the control process. Furthermore, the control process is in charge of running the server(s) and client(s) applications.

The multi-client to multi-server simulation environment control system (JULEP™) guarantees that all servers and all clients are synchronized with respect to an artificial time (simulation time) maintained by the control process.

The above described features and many other features and attendant advantages of the present invention will become apparent from a consideration of the following detailed description when considered in conjunction with the accompanying drawings.

### BRIEF DESCRIPTION OF THE DRAWINGS

Detailed description of preferred embodiments of the invention will be made with reference to the accompanying drawings.

FIG. 1 is a software process relationship model for one preferred embodiment of the present invention.

FIG. 2 is a software process relationship model for another preferred embodiment of the present invention.

FIGS. 3-6 represent a high level software flowchart for the present invention.

### DETAILED DESCRIPTION OF THE PREFERRED EMBODIMENTS

Disclosed herein is a detailed description of the best presently known mode of carrying out the invention. This description is not to be taken in a limiting sense, but is made merely for the purpose of illustrating the general principles of the invention. The section titles and overall organization of the present detailed description are not intended to limit the present invention.

The software tool may be written in any computer language, preferably C or C++, and run by a general purpose computer system, preferably a computer with ample primary and secondary memory storage, or any specialized hardware or firmware. Depending on the language used to construct and implement the software of the present invention, the software may have any number of classes, functions, subroutines, objects, variables, templates, module(s), lines of code, portions of code and constructs (collectively and generally, and as depicted by the flowcharts herein, “a process step”, “step”, “process”, “block”, “block step”, “application”, “module” or “software module”) to carry out the invention in successive stages as described and taught herein, and may be either a standalone software application, or employed inside of or called by another software application. The software process or software module may be constructed so that one portion of code in the application performs a plurality of functions, as for instance in Object Oriented programming (e.g., an overloaded process). The converse is also true in that a plurality of software modules or process steps may be constructed to perform the function of a single process step described herein, without loss of generality for the present invention. At any stage of the process step of the present invention, intermediate values, variables and data may be stored for later use by the program

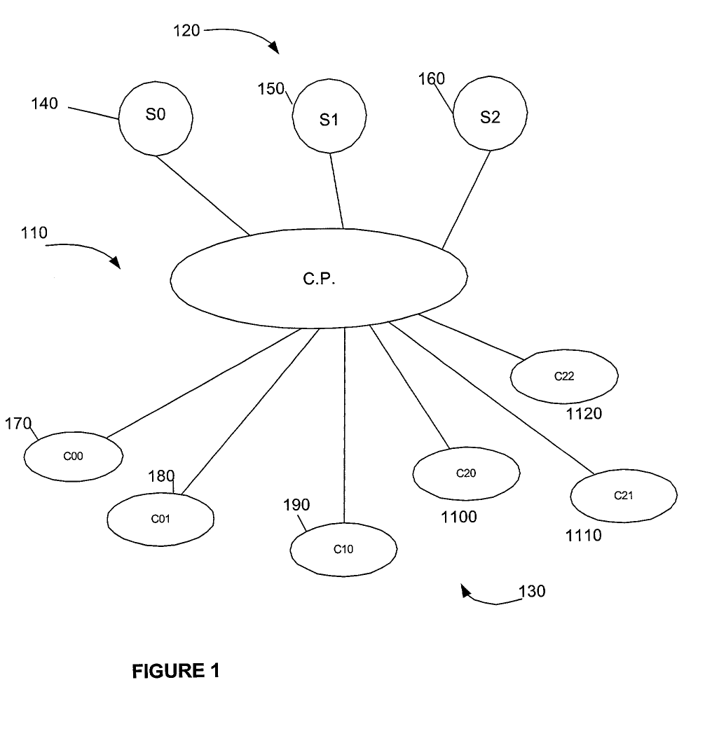

FIG. 1 shows a software process relationship model for one preferred embodiment of the present invention. Various entities are shown by oval or circular shapes, representative of both hardware (such as processor, primary and secondary memories, I/O such as keyboard, monitor and the like cooperating with the processor) and software residing in memory and operated by the processor. A control process (C.P.), 110, acts as an interface or intermediate layer between one or more servers 120 and one or more clients 130. Thus rather than the servers interacting directly with the clients, they interact first with the control process, performing the role of a traffic coordinator, which then redirects interprocess messages (or generally, data) to the clients. Likewise the control process 110 interfaces with data received from clients 130, and redirects the data to particular servers assigned to the clients. Furthermore, the control process has the ability to stop and start the execution of a client process and a server process, e.g., to pause the running of the client and server process applications, at select points in time, such as seconds or milliseconds of elapsed time from the start of the simulation. These points in time are called a synchronization points.

By way of example as shown in FIG. 1, during simulation, server 140 (node S₀), server 150 (node S1) and server 160 (node S2) are seen by all clients, such as by clients 170 (node C00), 180 (node C01), 190 (node C10), 1100 (node C20), 1110 (node C21) and 1120 (node C22) as a single entity or system during simulation. All client and server communications pass through and are regulated by control process 110.

It should be further noted that though the simulation program of the present invention runs on a computer system, it is not limited to simply simulating computers, such as a client-server network, but in fact can be used to simulate any system, e.g., Application Specific Integrated Circuits (ASICs), DSL modems, disk drive controllers, graphics processors, network interface adapters and entire communications networks and/or any other mechanical, electromechanical or electronic system.

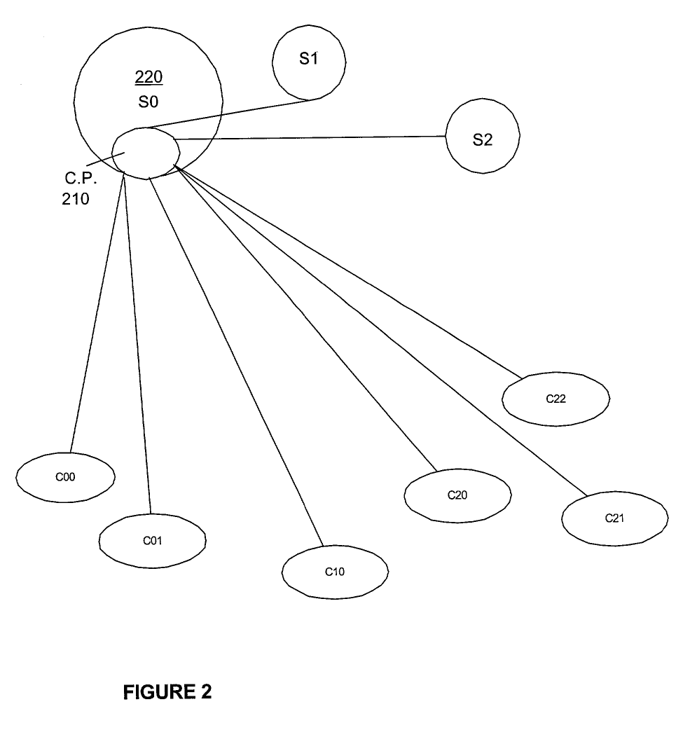

Though control process 110 in FIG. 1 is shown as a stand alone physical entity, other configurations are possible. For example, as shown in FIG. 2, adopting the same convention of labeling entities as in FIG. 1, the difference is that the control process entity 210, C.P., is now just a software entity residing in one of the servers, such as server 220, S₀. Nevertheless, as in the FIG. 1 embodiment, the control process acts as “traffic cop” or messaging broker between servers and clients, despite the control process being physically resident in one of the servers. In addition, the control process software application may be present as a software module that is resident in the code (e.g., instructions) comprising the software of one of the server applications, such as an external function. Other such configurations are possible without departing from the scope of the present invention.

Typical messages sent and received between client and server (via the control process) include the below message commands:

client messages (messages from clients to servers) include the messages—

‘peek’ (examine a value)

‘poke’ (set a value)

‘invoke’ (instructs the server to perform a task)

‘create event’ (sets up an event to watch for; events are expressions which are continuously evaluated as simulation progresses. When one of these expressions evaluates TRUE, i.e., a non-zero value, the associated event is said to have occurred)

‘destroy event’ (removes an event from the list of events to watch for)

‘simulate’ (simulate until an ‘event’ or synchronization point)

‘finish’ (exit).

server messages (messages from servers to clients) include the messages—

‘value’ (response to a peek)

‘acknowledge’ (response to the commands poke, invoke and finish; for invoke, if the task being performed by the simulator is expected to return results, the invoking process may use peek to retrieve the results)

‘event’ (an event occurred; this message includes a timestamp)

‘sync’ (a simulation synchronization point has been encountered).

Synchronization (sync) points are periodic pauses in the simulation at periodic points in time. All servers will synchronize at a predetermined interval, determined by the control process. The duration of the interval may vary as simulation progresses, but in general, it is held constant. All servers use the identical interval duration, and the interval duration is maintained by the control process. The interval duration may only be changed at sync points, and if the interval duration is changes, in a preferred embodiment all servers must change to the new interval. It is envisioned, however, that the interval duration may be different for different machines if the application is suitably modified to allow for this contingency.

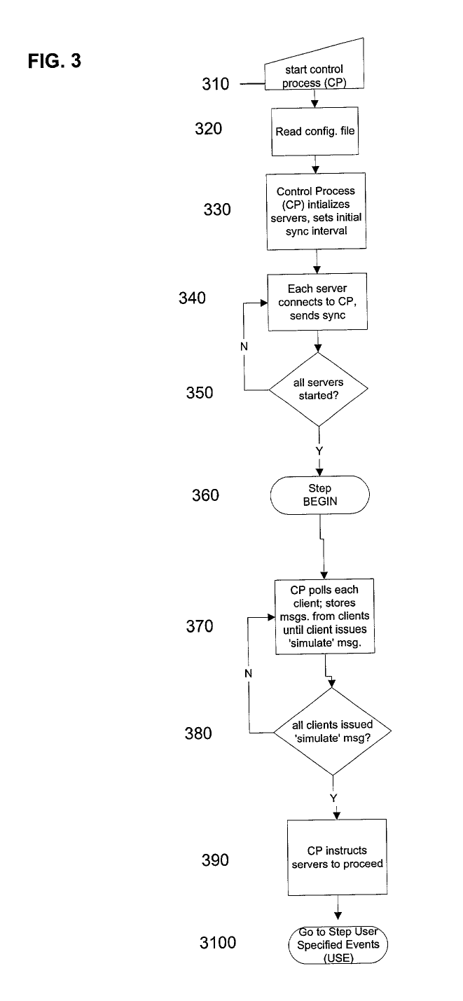

Turning attention now to FIG. 3, there is shown a high-level flowchart of a typical simulation session of the present invention. First, as shown in FIG. 3, a user starts up the control process (C.P.) or message broker module 310. Next, in block step 320, the control process module reads a configuration file, or text from a command line, which identifies the number of clients and servers, exactly what role each server/client plays, and other initialization factors. In process block step 330, the control process module starts each server and sets the initial synchronization interval. As stated above, sync points, which are the beginning and end points bounding a synchronization interval, are periodic pauses in the simulation, pauses in the execution of instructions by client and server processes. The synchronization interval, which may be thought of as the “granularity” of the artificial time (simulation time) that the simulation system of the present invention runs under, should not be set so small (e.g., smaller in duration than a computer system clock) that nothing can be accomplished during the sync interval by the simulation; nor should it be set excessively large, such as no sync point. In general, however, the operator of the system may set the sync interval at any suitable time, and the sync interval may be adjusted at sync points.

At step 340, each server connects or establishes a session with the control process module and sends the control process module a ready to synchronize message, a notification that the server is ready to simulate. In decision block step 350, the control process module first verifies that all servers have started, and, if so, the control process module starts the client(s) associated with the servers. Box 360 is an entry point for continuing the program; in step block 370 the control process module polls each client for messages. Polling order is not important, but the control process module must poll the clients in a predetermined identical manner each session to ensure repeatability. As the control process module polls clients, the control process accepts messages from clients and forwards them to server processes when the clients issue a ‘simulate’ message.

In step decision block 380, the client verifies whether all clients have issued such a ‘simulate’ message before proceeding. Once all clients have issued simulate messages, the control process module instructs the servers to proceed, step 390, which leads to the section of the flowchart labeled User Specified Events (U.S.E.), point box 3100.

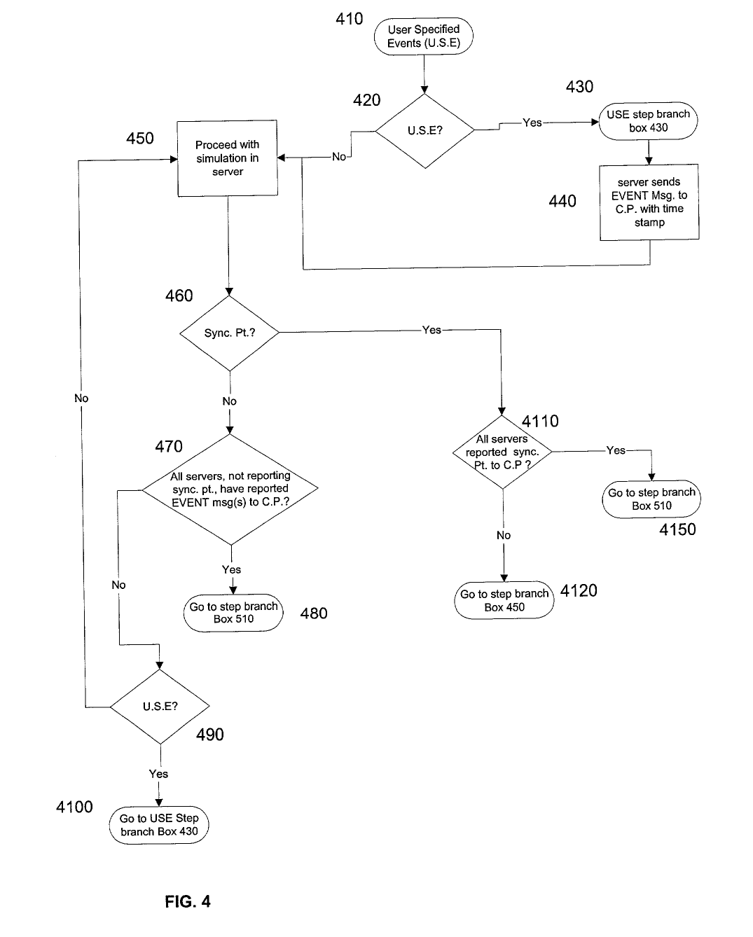

At box 410, FIG. 4, the portion of the software program concerned with User Specified Events is disclosed. User Specified Events (U.S.E.) are in general any events to watch for, and may for example be event driven or procedure oriented, and in a preferred embodiment arise in the server. Such User Specified Events are events that reside in the server application process that may, when triggered, such as when an event expression within the server process evaluates to TRUE, instruct the server to act in a specific way towards the client application process(es) that the server process controls. Typically such User Specified Events include interrupt driven events, such as arithmetic overflow, and events such as “Transmit Buffer Empty” (i.e., a buffer that stores data to be transmitted is empty), or “Transmit Buffer Full” (the opposite of “Transmit Buffer Empty”, in that the buffer that stores data to be transmitted is full of data), and the like. In decision block step 420, the program checks for the presence of such User Specified Events from the server.

In the simplest case, there are no user specified events and simulation proceeds until all servers reach a synchronization point. Thus in block step 450 simulation proceeds, and in decision block 460 the program checks for the presence of a sync point message from the server. If such a sync point message is present, decision block 4110 checks for whether all servers have reported sync points to the control process module. If all servers have not reported sync points to the control process module, simulation proceeds, as indicated in decision block 4120, which redirects the program to block step 450. If all servers have reported sync points to the control process module, then control is passed to the step 510 (marked “Step Branch Box 510”), as indicated by block step 4150.

Therefore if all servers have reached a sync point, and there are no U.S.E. events and the simulation has not finished, ultimately the control process module will repeat by returning control to the program to step point “BEGIN”, step box 360 in FIG. 3. Thus, absent any user specified events, once all servers have reached the sync point, the control process module instructs the servers to proceed again to the next sync point. In this manner the server simulators are kept in pseudo lockstep.

In situations where events are active, that is, the events have been created and will be detected at run-time, simulation proceeds as before, except that when a User Specified Event (U.S.E.) is encountered, such as indicated in the ‘YES’ branch of decision block 420 in FIG. 4, an ‘event’ message (marked EVENT in FIG. 4) is issued by the server for the client. The ‘event’ message is not sent directly to the client, however, but routed to the control process module. The ‘event’ message is included with a timestamp of the time, as indicated in block step 440, which is an artificial time (or simulation time) that all server processes are kept on, and maintained by the control process. The timestamp for this artificial time is typically started at an initial time equal to zero elapsed seconds at the start of the simulation program.

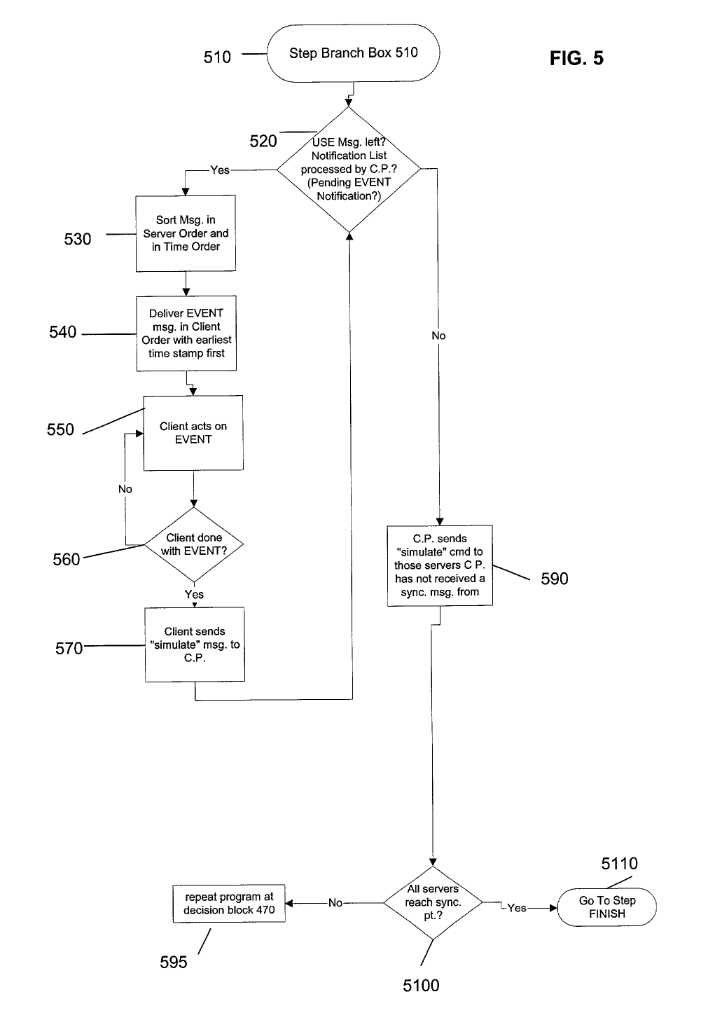

The control process module does not deliver this message (or any other event) to any clients until the control process is certain that all servers have simulated at least as far in time as the server simulator sending the ‘event’ message. The control process knows this either by receiving an event message from the server or a sync message (indicating that the server has reached the next sync point). Thus, for example, assuming no sync point has been detected, as in the ‘NO’ branch of decision block step 460 in FIG. 4, the program checks in decision block 470 whether all servers—that have not reported a sync point—have reported with ‘event’ messages, and, if so (i.e., block 480), proceeds to the point in the program marked 510, Step Branch Box 510 in FIG. 5. If not, the program continues to check for User Specified Events (U.S.E), as per decision block 490, and passing control of the program either back to block step 450 if no U.S.E. are detected, or, if a U.S.E is detected, control is passed to the USE step branch box 430 (block 430, as per block step 4100), and simulation continues.

Turning attention now to FIG. 5, once ‘event’ messages from all servers not reporting sync points have been received, as from the “Yes” branch of decision block 470, and assuming U.S.E. message(s) exist, as per decision block 520, that is, assuming there is a list of such U.S.E. messages, with the list termed the Pending Event Notification list, the messages received are sorted in server order and then in time order, as indicated in block 530 of FIG. 5.

Server order is a predetermined, consistently applied and repeating pattern or sequence of servers, listed in a sequence or queue by the control process. The queue or sequence can be any sequence of servers, such as, referring to FIG. 1, the sequence {S₀, S₁, S₂}. Time order is simply the ordering of events in chronological order, using the artificial clock kept by the control process (the artificial clock starts at an initial time equal to zero elapsed seconds when the simulator application program starts). Event messages associated with the earliest time stamp are delivered in client order, as indicated by block 540. Client order can be defined as whatever predetermined arbitrary (but consistently applied) ordering of clients (or queue), with respect to a server(s), that the control process uses to send messages to clients. Thus, clients and servers may be ordered in any manner, but the same ordering method must be used to ensure repeatability. Referring to FIG. 1, such a client order queue may be, by way of example, clients {C₀₀, C₀₁} for server So, client {C₁₀} for server S₁, and clients {C₂₀, C₂₁, C₂₂} for server S₂.

In block 550, the client acts on the ‘event’ message, proceeds with simulation, and when the client is done with the ‘event’ message, as indicated by decision block 560, proceeds to block 570 where the client sends a ‘simulate’ message for the server. The ‘simulate’ message from the client is routed to the control process, which does not forward any ‘simulate’ message to the servers until all clients with a Pending Event Notification list have received any ‘event’ message(s) and had the opportunity to act upon them. Thus control is passed back by the program to the decision block step 520, and the process is repeated until there are no more U.S.E messages left in the Pending Event Notification list.

If the Pending Event Notification list is exhausted, the “No” branch of decision block 520 is chosen, control is passed from block 520 to block step 590, which means that the Pending Event Notification list has been processed in its entirety by the control process, all clients have received and acted upon any ‘event’ messages, and the control process module sends a ‘simulate’ command message only to those servers that it has not yet received a sync message from, that is, the servers that sent the control process event messages, which would correspond to all the servers in decision block 470 in FIG. 4. Thus, proceeding to the next step at decision block step 5100, and assuming any such servers are present, by traversing the “No” branch of decision block 5100, control of the program is passed back to decision block 470, as indicated by block step 595, and the process is repeated. Note that in the program it may be possible that there are cases where a U.S.E. event will occur at exactly the same time corresponding to a sync point; in the event this happens, all events would be processed before the sync point is recognized, thus events are processed before sync points where there is such a collision.

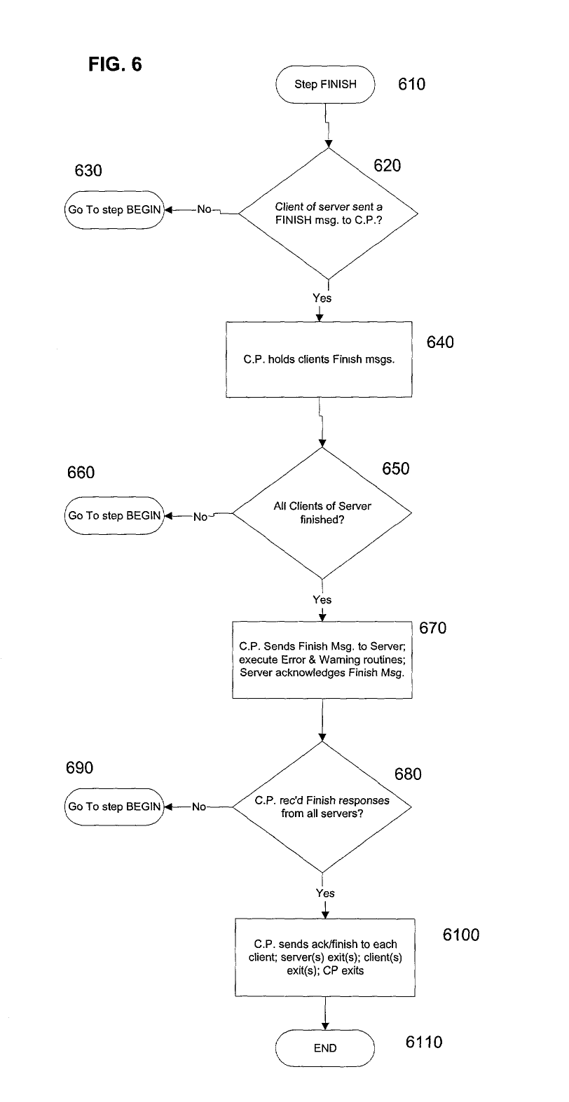

At some point, there will be no more such servers reporting ‘event’ messages, and all servers will have reached the next sync point, which should be the same sync point for all servers. At this point, as indicated by the “Yes” branch of decision block 5100, control is passed to the point in the program flowchart marked step FINISH, as indicated by point 5110, corresponding to step point box 610 (step FINISH) in FIG. 6.

Turning now to the finish portion of the software flowchart, FIG. 6, eventually each client will complete and send a ‘finish’ (exit) message to the control process, as checked for in decision block 620. If so, the program passes control along the “Yes” branch of decision block 620, and the control process will hold each client's ‘finish’ message until all clients have sent ‘finish’ messages, and have finished, box 640; otherwise control is passed along the “No” branch of decision block 620 and control is passed back to step BEGIN (box 360 in FIG. 1), as indicated in block 630. Afterwards it is checked to see if all clients of the server are finished, as indicated by the “Yes” branch of decision block 650, otherwise control is passed back to point BEGIN (box 360 in FIG. 1), as indicated by step 660. Assuming that all clients of the server have finished, the control process will send a ‘finish’ message to each server of the client(s) that have all finished, as indicated by block step 670. Such ‘finish’ messages include “error” and “warning” counts (i.e., how many errors and warnings have been observed by the process finished during the simulation). The control process sums the errors for all clients finished as well as the warnings for all clients, and passes this information to each server in the finish message the server receives (block 670).

The only valid response to a ‘finish’ message is either ‘finish’ or ‘acknowledge’. If a server wishes to update the error or warning information from the control process, the server should respond with a finish message, which includes new error and warning counts. Otherwise, the server should simply acknowledge the ‘finish’ message it receives from the control process. Thus if the control process does not receive a proper ‘finish’ message, control can be passed back to step BEGIN (box 360 in FIG. 1), as indicated in step 690.

As indicated by block 6100, after the control process has received a suitable response from all servers, the server sending the suitable response to a ‘finish’ message will terminate the simulation and exit, and an acknowledge (or finish, if the error/warning information has been changed) is then forwarded to each client. As each client receives the acknowledge (or finish), it will also exit. Finally, the control process itself will exit and the program ends (block 6110).

Though the preferred embodiments are disclosed in the present invention, alternative mechanisms may be employed without departing from the scope of the invention. It is to be understood that while the invention has been described above in conjunction with preferred specific embodiments, the description and examples are intended to illustrate and not limit the scope of the invention, which is defined by the scope of the appended claims.

We claim:

1. In a computer system, an improved multi-client to multi-server software system comprising:
at least one server process software application capable of sending and receiving messages;
at least one client process software application to said server process software application capable of sending and receiving messages;
a control process software module for passing said messages to and from said server process and client process.

2. The invention of claim 1, wherein:
said server process and said client process send and receive messages only to and from said control process software module, and communication between said server process and said client process occurs under direction of said control process, said control process acts as a message broker between said server process and said client process.

3. The invention of claim 2, wherein:
said control process controls the running of said server process and said client process;
said control process sets synchronization points, said synchronization points comprising points in time where said control process pauses the running of said server process.

4. The invention of claim 3, further comprising:
a plurality of server processes, a plurality of client processes, and each of said plurality of server processes communicating via said control process with a predetermined number of said plurality of client processes associated with each of said server processes, with said control process controlling said plurality of server and client processes.
wherein said control process stops the running of said server process when each of said server process reaches a synchronization point, said synchronization points in time being elapsed time from the start of simulation by said control process.

5. The invention of claim 2, further comprising:
a plurality of client processes associated with said server process, each of said plurality of client processes communicating via said control process with said server process, with said control process controlling said server process and said client processes.

6. The invention of claim 2, further comprising:
a plurality of server processes, a plurality of client processes, and each of said plurality of server processes communicating via said control process with a predetermined number of said plurality of client processes associated with each of said server processes, with said control process controlling said plurality of server and client processes.

7. The invention of claim 6, wherein:
said control process sets up a predetermined ordered queue of said server processes and a predetermined ordered queue of said client processes, and said messages are sent to and from client and server according to said predetermined ordered queue of server processes and client processes.

8. The invention of claim 3, wherein:
said server process evaluates a predetermined event expression to determine the occurrence of an event in said server process, and;
at least one said server process sends a event expression message to said control process upon the occurrence of said predetermined event expression in said server process, said event expression message containing a time stamp, said time stamp an indication of the time at which said event occurred in said server process.

9. The invention of claim 8, further comprising:
a plurality of server processes, a plurality of client processes, and each of said plurality of server processes communicating via said control process with a predetermined number of said plurality of client processes associated with each of said server processes, with said control process controlling said plurality of server and client processes.

10. The invention of claim 9, wherein:
said control process maintains said time stamp for each server, said time stamp being an indication of the time elapsed from the start of the control process, and said time elapsed proportional to the time elapsed in said control process between said synchronization points.

11. The invention of claim 9, wherein:
said control process sets up a server order queue comprising a predetermined ordered queue of said server processes and a client order queue comprising a predetermined ordered queue of said client processes, and said messages are sent to and from client and server according to a predetermined ordered queue comprising said server order queue and said client order queue.

12. The invention of claim 11, wherein:
said control process receives a plurality of said event expression messages from said server processes, and said control process sorts said event expression messages received from said server processes according to the server order queue;
said control process ordering each of said event expression messages within said server order queue according to the earliest time of said time stamp at which said event occurred in said server process.

13. The invention of claim 11, wherein:
said control process delivers said sorted event expression messages to said client processes associated with said server processes according to said predetermined ordered queue of client processes.

14. The invention of claim 5, wherein:
each of said plurality of client processes sends a finish message, indicating said client process is finished running, to said control process for communication to said server process associated with said client process, when each of said client processes is finished running;
said control process holds each of said finish messages from said plurality of client processes until all of said plurality of client processes associated with a server process are finished running; and,
wherein said control process sends a finish message to said server indicating the client processes are finished running.

15. The invention of claim 14, wherein:
each of said plurality of server processes sends a finish message, indicating said server process is finished running, to said control process when said client processes associated with each of said server processes are finished;
said control process holds each of said finish messages from said plurality of server processes until all of said plurality of server processes have sent said finish messages to said control process;
wherein said server processes, client processes, and control process finish operations and exit.

16. The invention of claim 2, further comprising:
a plurality of client processes, said plurality of client processes associated with a predetermined server process, communicating with said server process under the direction of said control process;
a plurality of server processes, each of said server processes evaluates an event expression to determine the occurrence of an event in said server process, and each of said server processes sends an event expression message to said control process upon the occurrence of said event in said server process, said event expression message containing a time stamp indicating the time at which said event occurred in said server process.

17. The invention of claim 16, further comprising:
said control process software module sets up a plurality of predetermined ordered queues comprising a client ordered queue of client applications in a particular order, a server ordered queue of server applications in a particular order, and a time ordered queue of event expression messages received from said plurality of server applications, said time ordered queue ordered according to the earliest in time event expression message.

18. The invention of claim 16, wherein:
said control process software module resides within said server process application, in the code comprising said server process application.

19. A server-client computer simulation system comprising:
a computer comprising a processor, primary and secondary memory, means for I/O;
at least one server comprising a processor, primary and secondary memory, means for I/O, and a server application residing in said memory and operating said processor;
at least one client comprising a processor, primary and secondary memory, means for I/O, and a client application residing in said memory and operating said processor;
a control process software module residing in said computer memory, said control process software module acting as a message broker between said server application and said client application, for passing messages between said server application and said client application, and communication between said server application and said client application controlled and directed by said control process software module, said server-client computer simulation system acting to simulate a device in a repeatable manner.

20. The invention of claim 19, wherein:
said device simulated is a device selected from the group consisting of electrical devices, mechanical devices, electromechanical devices, computer networks, DSL modems, ASICs disk drive controllers, graphics processors, network interface adapters and communications networks.

21. The invention of claim 19, wherein:
said control process software module controls said server application and said client application, and said control process sets synchronization points for said server application comprising points in time where said control process software module pauses the running of said server application.

22. The invention of claim 21, wherein:
said control process software module comprises a synchronization varying software module for varying the elapsed time duration between said synchronization points.

23. The invention of claim 21, wherein:
said control process stops all of said servers upon said servers reaching a synchronization point.

24. The invention of claim 19, further comprising:
a plurality of client applications, said plurality of client applications associated with said server application, and communicating with said server application under the direction of said control process software module.

25. The invention of claim 24, wherein:
a plurality of server applications, said plurality of server applications communicating via said control process software module with a predetermined number of said plurality of client applications associated with each of said server applications.

26. The invention of claim 25, wherein:
said control process software module sets up a plurality of predetermined ordered queues comprising a client ordered queue of client applications and a server ordered queue of server applications.

27. The invention of claim 21, wherein:
a plurality of server applications, a plurality of client applications associated with said server applications, said plurality of server applications communicating via said control process software module with said predetermined number of said plurality of client applications associated with each of said server applications; wherein,
each of said server applications evaluates an event expression to determine the occurrence of an event in said server application, and each of said server applications sends an event expression message to said control process software module upon the occurrence of said event in said server application, said event expression message containing a time stamp indicating the time at which said event occurred in said server process.

28. The invention of claim 27, wherein:
said control process software module sets of a plurality of predetermined ordered queues comprising a client ordered queue of client applications in a particular order, a server ordered queue of server applications in a particular order, and a time ordered queue of event expression messages received from said plurality of server applications, said time ordered queue ordered according to the earliest in time event expression message, and said control process software module passing messages to and from said server and said client applications according to at least one of said predetermined ordered queues.

29. A method of carrying out a simulation employing multiple clients and multiple servers comprising the steps of:
running a plurality of server process software applications that simulate a server application;
running a plurality of client process software applications that each simulate a client application, each of said client applications associated with at least one of said server applications;
running a control process software application that acts as a message broker between said servers and clients, all messages between servers and clients managed and controlled by said control process, and said control process controlling the operation of said servers;
maintaining the elapsed time of said simulation in said control process software application.

30. The invention of claim 29, further comprising the steps of:
determining the occurrence of a predetermined event in said server applications;
maintaining, in said control process, a list of client applications and server applications, and a list of messages for the occurrence of said predetermined events that occur in said server applications;
communicating said predetermined events from said server applications to said client applications.

31. The invention of claim 30, further comprising the steps of:
ordering, in said control process, said messages of said predetermined events according to the earliest time that such predetermined events occurred in said server applications; and,
delivering said messages to said client applications according to said ordering of said predetermined events.

32. The invention of claim 30, wherein:
ordering, in said control process, said list of messages for the occurrence of said predetermined events according to (1) time order, the earliest time that such predetermined events occurred in said server applications, (2) server order, an ordering according to a predetermined queue of servers, and, (3) client order, an ordering according to a predetermined queue of clients.

33. The invention of claim 32, wherein:
sorting said list of messages of said predetermined events according to said server order and said time order;
delivering, using said control process, said messages of said predetermined events from said control process to said plurality of client applications according to said client order and said time order, with the earliest messages delivered first.

34. The invention of claim 29, further comprising the steps of:
setting a plurality of synchronization points comprising elapsed time in the simulation of servers and clients;
stopping said servers upon each of said servers reaching said synchronization points.

35. The invention of claim 34, further comprising the steps of:
varying the duration of elapsed time between said synchronization points by way of said control process setting the duration of time to elapse between synchronization points.

36. The invention of claim 29, further comprising the steps of:
setting a plurality of synchronization points comprising elapsed time in the simulation of servers and clients;
determining the occurrence of a predetermined event in said server applications;
maintaining, in said control process, a list of client applications and server applications, and a list of the occurrence of said predetermined events that occur in said server applications;
communicating said predetermined events from said server applications to said client applications;
ordering, in said control process, said predetermined events according to the earliest time that such predetermined events occurred in said server applications; and,
delivering messages to said client applications relating to said predetermined events according to said ordering of said predetermined events.

37. The invention of claim 36, further comprising the steps of:
determining through said control process whether said client applications are finished with said simulation through the occurrence of a message indicating said client applications are finished;
determining through said control process whether said server applications are finished with said simulation through the occurrence of a message indicating said server applications are finished;
said control process acknowledging said client and server application finish messages and said simulation terminating when said client and server applications have all finished.

38. The invention of claim 29, further comprising the steps of:
polling each of said plurality of client process software applications with said control process software application in a predetermined manner;
temporarily storing said messages from said client process software applications, until such time that said client process software applications issue a predetermined message to simulate to said control process;
forwarding said messages from said client process software applications to said server process software applications associated with said client process software applications upon the occurrence of said predetermined message to simulate. A simulator apparatus comprising:
means for sending and receiving messages in a computer system, said means for sending and receiving messages acting as a server;
means for sending and receiving messages in a computer system, said means for sending and receiving messages acting as a client;
means for sending and receiving messages server means and said client means, said means for sending and receiving messages acting as a message broker between said server means and said client means, and said means for sending and receiving messages able to stop the running of said server means and said client means at predetermined points in time comprising synchronization points; wherein,
said server means, said client means and said message broker means act as a simulator performing a repeatable simulation.

40. The apparatus according to claim 39, wherein:
said server means evaluates a predetermined event expression to determine the occurrence of an event in said server means, and;
said server means sends a event expression message to said message broker means upon the occurrence of said predetermined event expression in said server means, said event expression message containing a time stamp, said time stamp an indication of the time at which said event occurred in said server means;
a plurality of said server means and said client means, wherein said message broker means delivers said event expression messages between said server means and said client means according to a predetermined queue.
